(19) United States
(12) Patent Application Publication
(10) Pub. No.: US 2008/0007959 A1
(43) Pub. Date: Jan. 10, 2008

(54) Backlight module locating device and method thereof

(75) Inventors: Chin-Hui Chen, Yangmei Taoyuan (TW); Kuo Feng Cheng, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-BRIDGE ELECTRONICS CO., LTD.

(21) Appl. No.: 11/706,416

(22) Filed: Feb. 15, 2007

(30) Foreign Application Priority Data
Jun. 30, 2006 (TW) 095123771

(51) Int. Cl. F21V 17/00

(52) U.S. Cl. 362/457

(57) ABSTRACT

A locating device and method therefore for a first and a second parts of a backlight module by having, for example, a metal back plate or a metal reflection layer and a plastic frame secured to each other and made an integrated party without relying upon any other assembly part, e.g., a screw, or an assembly structure, e.g., an opening and a locking hook, thus to shorten assembly process and to improve assembly strength between the metal back plate or the metal reflection layer and the plastic frame.

### BACKGROUND OF THE INVENTION

(a) Field of the Invention

The present invention is related to a backlight module locating device and a method thereof, and more particularly, to a locating installation between a first part and a second part in a backlight module without depending on any other assembly parts or structure to make both of the first and the second parts becoming an integrated part.

(b) Description of the Prior Art

As the fabricating technology for thin film transistor (TFT) rapidly advances, liquid crystal display (LCD) for providing advantages of light and thin, power saving, and radiation free has been massively applied in electronic products including PDA, Notebook, digital camera, camcorder, and mobile phone. Continuous upgrading of LCD quality and price cut of LCD due to ambitious inputs into R&D and up-scaling production facilities further promote fast expansion in LCD-applied field.

Generally, an LCD is not a light emitting display device; it relies upon a backlight module to produce display function. Therefore, in assembling the LCD, the backlight module and liquid crystal panel are mounted in a frame of the display in sequence. As illustrated in FIG. 1 of the accompanying drawings, an assembling procedure of a side emitting backlight module of the prior art as illustrated in FIG. 1 involves having a lamp 15 mounted in a metal reflection layer 11; a light guide plate 13 and multiple optical films (not illustrated) are placed in sequence on top of an upper surface of a reflection film 14; a metal back plate 16 is externally disposed to the reflection layer 11 and a plastic frame 12; a liquid crystal panel is mounted on an upper surface of those optical films (not illustrated); and finally a metal outer frame 17 is place don the liquid crystal panel. Wherein, an opening 161 provided on the metal back plate 16 and a locking hook 121 provided on the plastic frame 12 are engaged to each other to secure the metal reflection layer 11, the plastic frame 13, and the metal back plate 16 in position to one another.

FIG. 2 is a schematic view of an assembly of a side emitting backlight module adapted in a notebook computer. Similarly, the lamp 15 is mounted in the metal reflection layer 11 before being placed on the plastic frame 12, a screw 18 is locked into where between and secure both of the metal reflection layer 11 and the plastic frame 12 to each other; a light guide plate and multiple optical films (not illustrated) are placed in sequence of an upper surface of a reflector film; and finally the metal outer frame 17 is placed on the liquid crystal panel to complete the assembly of a displayer.

In the course of assembly, a grounding elastic member is usually adapted to the plastic frame for the grounding elastic member to contact the metal outer frame so to exclude electric charges through the metal outer frame. To achieve the purpose, a common practice is to engage the metal reflection layer and the grounding elastic member with a screw while securing both to the plastic frame at the same time; and in a subsequent process of locating the metal outer frame and the plastic frame, a locking point disposed on the grounding elastic member is located to the surface of the metal outer frame.

However, either assembly procedure described above is found with the following flaws:
1. Whereas the metal back plate or the metal reflection layer and the plastic frame are secured to teach other in position by the engagement between the opening and the locking hook, the opening must be pre-formed at where appropriately in the molding process of the metal back plate or the metal reflection layer, and the molding of the plastic frame must be reserved with the hook. As a result, the mold development becomes more complicated and longer time for assembly is required since both of the opening and the locking hook must be engaged before going to a next step of locking process.
2. When the metal backplate or the metal reflection layer and the plastic frame are secured to each other by means of a screw, the screw must be precisely fastened at the certain location. Any poor torque applied to the screw or any biased location of fastening could wind up poor assembly strength and being vulnerable to loosen up of the backlight module.
3. The grounding elastic member is secured in position with the metal backplate or the plastic frame merely by latching, it could easily get loosened up from the metal back plate or the plastic frame either in the course of handling of the display or in the subsequent process of assembly at the system fabricator's facilities
   Furthermore, in the assembly procedure for a direct backlight module, each lamp is first secured to a metal reflection layer with a fixation holder before placing in sequence a diffuser and multiple optical films on top of the metal reflection layer, and finally a liquid crystal panel is mounted on the upper surface of those optical films to complete the assembly of a display. Wherein, the lamp fixation holder is fastened to the metal reflection layer by means of a screw. Again, Similar problem of poor torque applied to the screw or any biased location of fastening exists that could wind up poor assembly strength and being vulnerable to loosen up of the display.

### SUMMARY OF THE INVENTION

The primary purpose of the present invention is to provide a locating device and a method thereof for a first part and a second part in a backlight module to secure each other in position. For example, the first part related to a metal back plate or a metal reflection layer and the second part related to a plastic frame become an integral part in a backlight module without relying upon other assembly parts, e.g. a screw, or an engagement, e.g., an opening and a locking hook to not only shorten the process but also increase the assembly strength between the metal back plate or the metal reflection layer and the plastic frame.

To achieve the purpose, the first part of the present invention (e.g., the metal back plate, a grounding elastic member, the metal reflection layer or a solid substance) is provided with a locating portion. When the second part (e.g., the plastic frame) is molded, the locating portion is inserted into a molding area of the second part; and once the molding material is injected, the locating portion extends into and is secured in the second part for both of the first and the second parts to become an integrated part to skip the assembly process and to improve the assembly strength between the first and the second parts.

### BRIEF DESCRIPTION OF THE DRAWINGS

FIG. 1 is a schematic view showing a construction of a plastic frame and a metal back plate in a backlight module of the prior art are assembled and secured to each other.

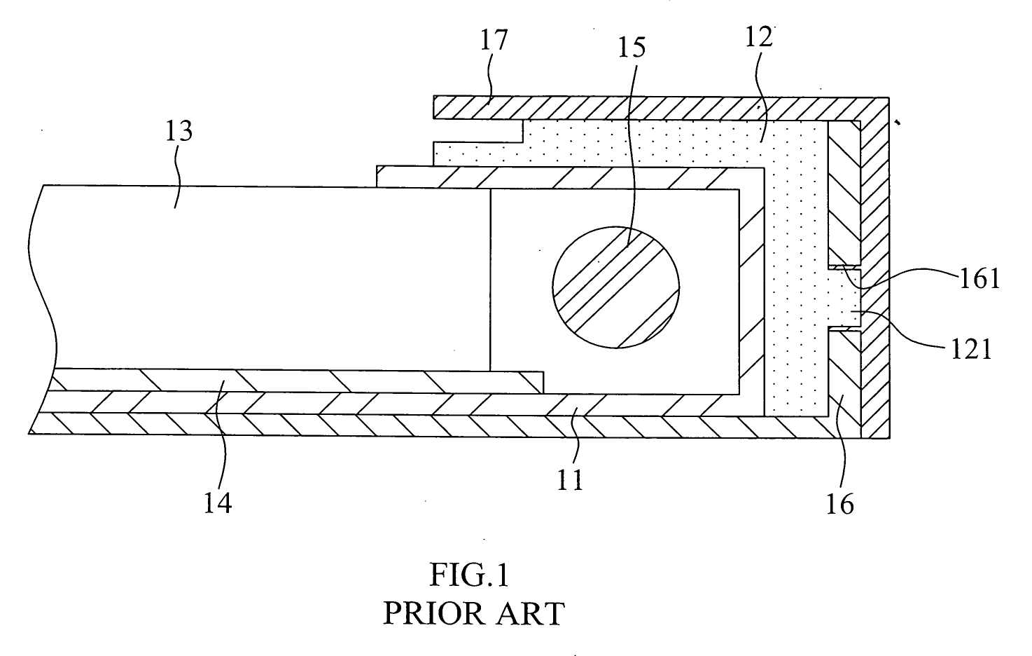

FIG. 2 is perspective view showing a construction of a plastic frame and a metal back plate in another prior art are assembled and secured to each other.

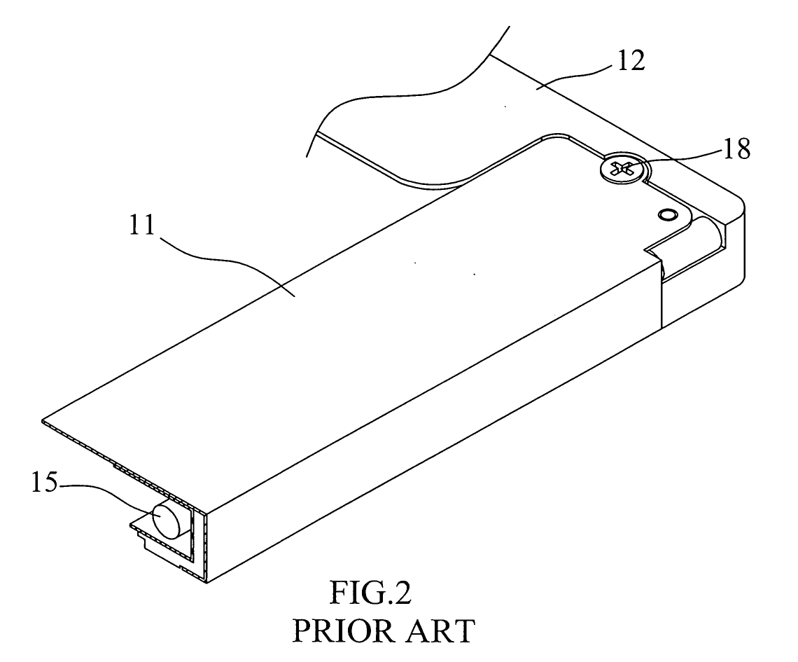

FIG. 3 is a perspective view of a construction of locating method of a first preferred embodiment of the present invention.

FIG. 4 is a schematic view showing a locating construction for a first part and a second part in the present invention.

FIG. 5 is an exploded view of a side emitting backlight module in the present invention.

FIG. 6 is a schematic view showing a construction of a direct backlight module in the present invention.

FIG. 7 is an exploded view of a locating construction of a second preferred embodiment of the present invention.

FIG. 8 is an exploded view of a locating construction of a third preferred embodiment of the present invention.

### DETAILED DESCRIPTION OF THE PREFERRED EMBODIMENTS

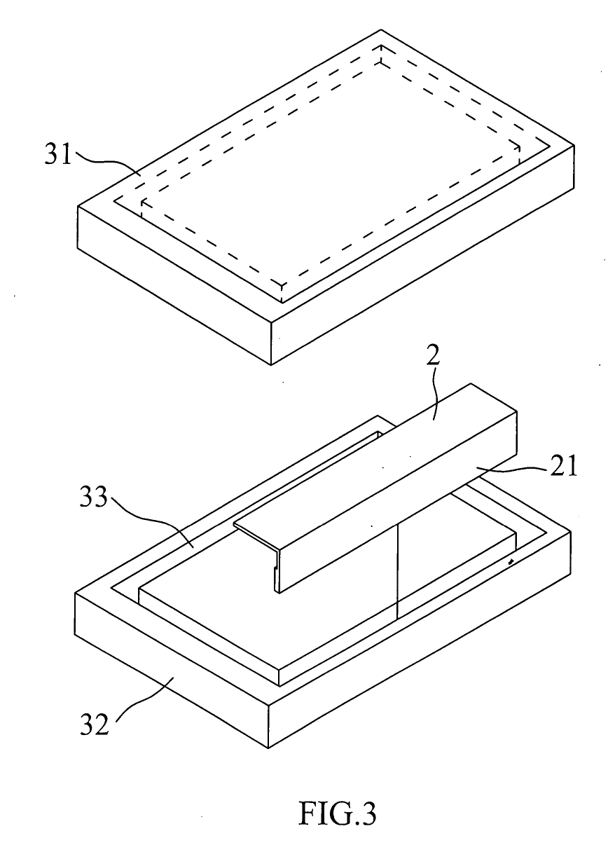

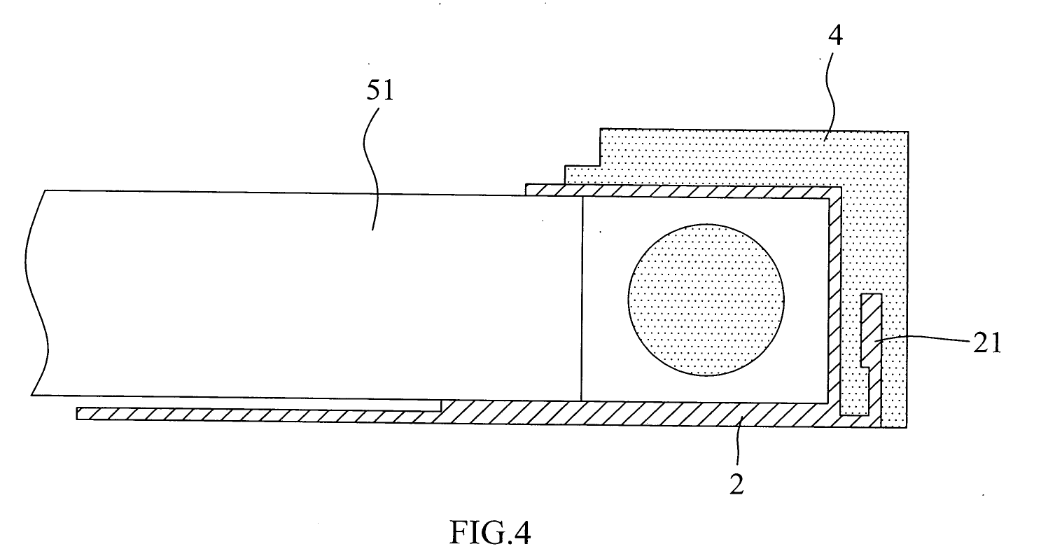

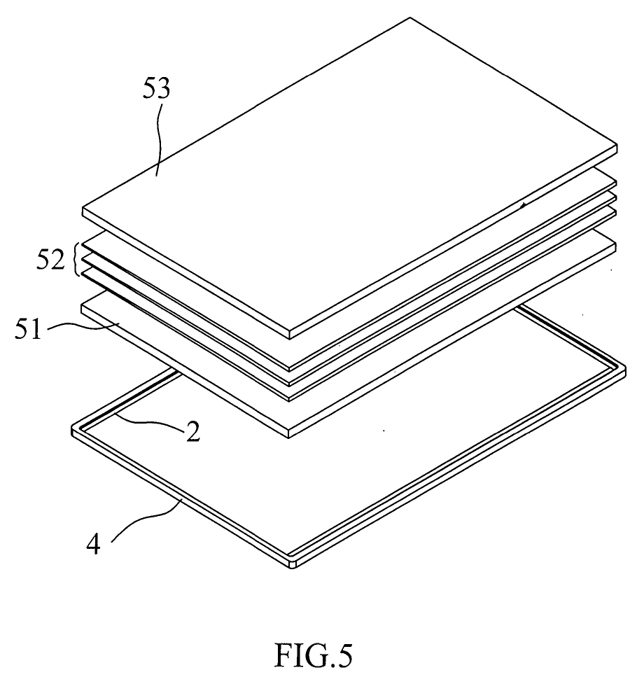

Referring to FIG. 3 for a locating method of a backlight module of a first preferred embodiment of the present invention, upon a upper die 31 and a lower die 32 are closed upon each other to define a molding area 33, a material is injected into the molding area 33 for a second part to be molded in shape.

Wherein, a locating portion 21 is disposed to a first part 2. Before injection the molding material, the locating portion 21 is placed in the molding area 33. When the molding material is injected, cooled and molded in shape, the locating portion 21 extends into the second part and is secured in position. As illustrated in FIGS. 4 and 5, a second part 4 is related to a plastic frame and the first part 2 is related to a metal back plate or a metal reflection layer; both of the plastic frame and the metal back plate or the metal reflection layer are made in an integrated part to facilitate assembling a light guide plate 51, multiple optical films 52, and a liquid crystal panel 53 on the plastic frame to complete the assembly of a side emitting backlight module display without relying upon other assembly parts, e.g., a screw, or an assembly engagement, e.g., an opening and a locking hook. The locating method of the present invention not only shortens the assembly process but also improves the assembly structure between the plastic frame and the metal back plate or the metal reflection layer to prevent them from being vulnerable to fall out of place. The first part may be related to a grounding elastic member and is made in an integral part with the plastic frame.

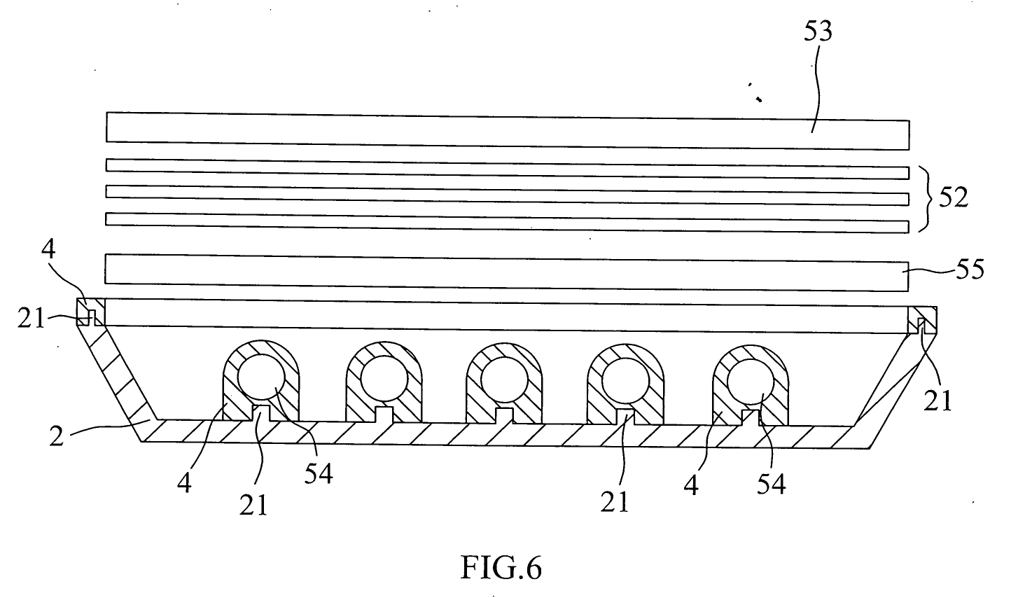

Additionally, the present invention is applied in the assembly of a direct backlight module as illustrated in FIG. 6, the second part 4 is related to a plastic frame or a lamp fixation holder and a first part 2 is related to a metal reflection layer and adapted with a locating portion 21. Upon the second part is molded, the location part extends and is secured in the second part 4. The lamp fixation holder is made in an annular form to receive insertion of a lamp 54. A diffuser 55, multiple optical films 52, and a liquid crystal panel 53 are then mounted in sequence on top of the lamp fixation holder to complete the assembly of a direct back light module display.

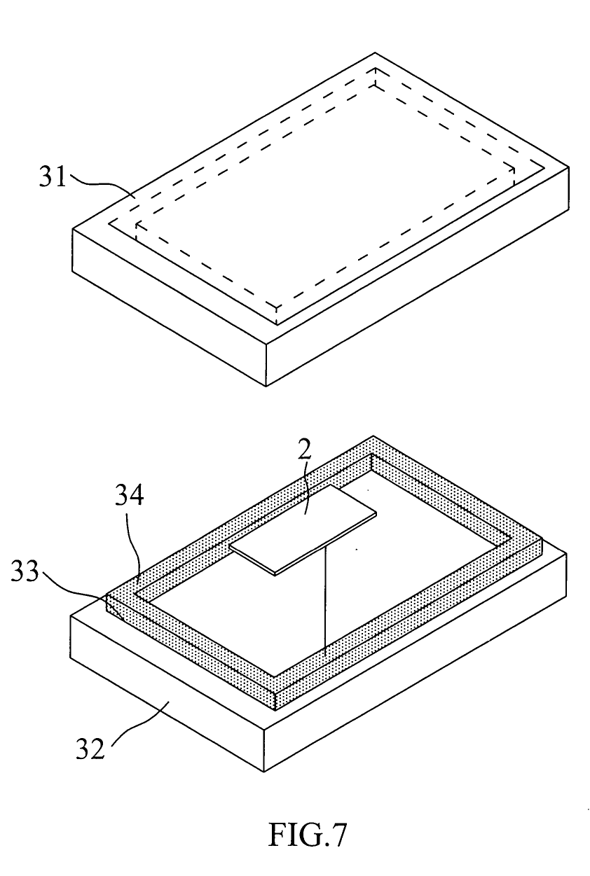

In a second preferred embodiment of the present invention as illustrated in FIG. 7, a second part is molded in shape by injection a molding material 34 into the molding area 33 defined by the upper mold 31 and the lower mold 32 when both molds are closed up to each other. Upon injecting the molding material into the molding area 33 and before the molding material is cured, one side of the first part 2 is made to contact the molding material 34 for both of the first part and the second part to bind to each other by taking advantage of the infusion status of the molding material 33. Once the molding material 33 cools down and gets solidified, both of the first and the second parts are secured to each other to become an integrated part.

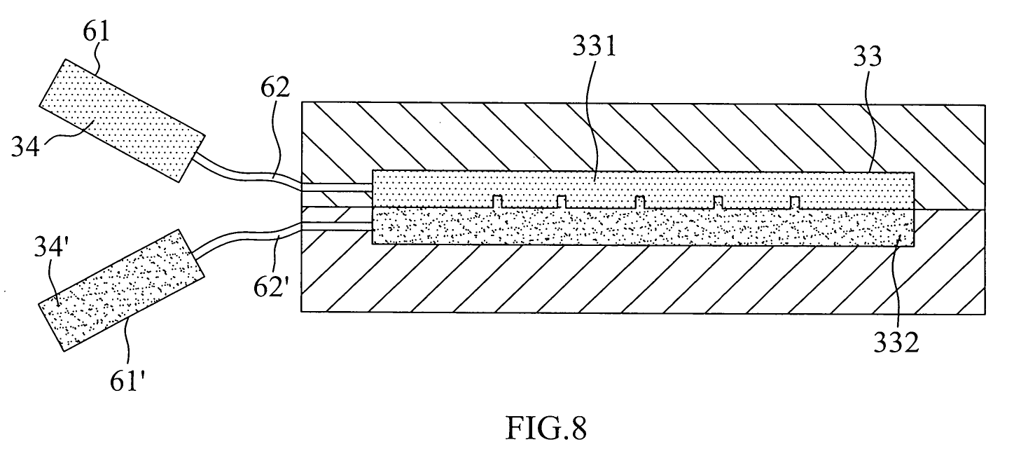

As illustrated in FIG. 8 for a third preferred embodiment of the present invention, two different types of molding materials 34, 34′ are respectively loaded into two feeding cylinders 61, 61′ for two injection nozzles 62, 62′ to inject both molding materials 34, 34′ into the molding area 33 comprised of a first and a second pre-molding areas 331, 332 to form a construction of an integrated part of the first and the second parts.

It is to be noted that in any of those three preferred embodiments described above, both of the first and the second parts may be made of heterogeneous materials (e.g., metallic or solid and plastic or two different types of plastic materials). The locating method allows both of the first and the second parts of the backlight module to become an integral part without relying upon any other assembly part (e.g., a screw) or an assembly structure (e.g., an opening and a locking hook) for a shorter assembly process while increasing the assembly strength for the backlight module.

The prevent invention provides a locating device and method thereof for a backlight module, and the application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A backlight module locating device includes a first part and a second part; the first part containing a locating portion; and the locating portion extending into the second part when the second part is molded in shape.

2. The backlight module locating device as claimed in claim 1, wherein the first part relates to a metal back plate, a grounding member, a metal reflection layer or a solid substance.

3. The backlight module locating device as claimed in claim 1, wherein the second part relates to a plastic frame, and a light guide plate or a diffuser is mounted on the plastic frame.

4. The backlight module locating device as claimed in claim 1, wherein the second part relates to a lamp fixation holder made in an annular shape to receive insertion of a lamp, and a diffuser is mounted on the lamp fixation holder.

5. A backlight module locating device includes a first part and a second part; the first part contacting a molding material of the second part before the molding material is cured; and both of the first and second parts are secured to each other and made in an integrated part when the molding material is solidified.

6. The backlight module locating device as claimed in claim 5, wherein the first part relates to a metal back plate, a grounding member, a metal reflection layer or a solid substance.

7. The backlight module locating device as claimed in claim 5, wherein the second part relates to a plastic frame, and a light guide plate or a diffuser is mounted on the plastic frame.

8. The backlight module locating device as claimed in claim 5, wherein the second part relates to a lamp fixation holder made in an annular shape to receive insertion of a lamp, and a diffuser is mounted on the lamp fixation holder.

9. A backlight module locating method includes the following steps: providing a first part disposed with a locating portion; providing a molding area for the second part, and the molding area being defined by an area formed upon both of a first and a second molds are closed up to each other; placing the first part in the molding area through the locating portion; injecting a molding material to cover up the locating portion; and extending the locating portion into the second part upon the second part is molded in shape to make both of the first and the second parts to be secured to each other in position.

10. The backlight module locating method as claimed in claim 9, wherein the first part relates to a metal back plate, a grounding member, a metal reflection layer or a solid substance.

11. The backlight module locating method as claimed in claim 9, wherein the second part relates to a plastic frame, a light guide plate or a diffuser is mounted on the plastic frame; or the second part relates to a lamp fixation holder made in an annular shape to receive insertion of a lamp, and a diffuser is mounted on the lamp fixation holder.

12. A backlight module locating method includes the following steps: providing a first part; providing a molding area for the second part, and the molding area being defined by an area formed upon both of a first and a second molds are closed up to each other; injecting a molding material and having one side of the first part to contact the molding material before the molding material is cured; and allowing the molding material to cool down and get solidified for both of the first and the second parts to be secured to each other in position and become an integrated part.

13. The backlight module locating method as claimed in claim 12, wherein the first part relates to a metal back plate, a grounding member, a metal reflection layer or a solid substance.

14. The backlight module locating method as claimed in claim 12, wherein the second part relates to a plastic frame, and a light guide plate or a diffuser is mounted on the plastic frame.

15. The backlight module locating method as claimed in claim 12, wherein the second part relates to a lamp fixation holder made in an annular shape to receive insertion of a lamp, and a diffuser is mounted on the lamp fixation holder.

16. A backlight module locating method for forming an integrated part construction for a first part and a second part using two different types of molding materials respectively injected in sequence into a molding area.

17. The backlight module locating method as claimed in claim 16, wherein the first part relates to a metal back plate, a grounding member, a metal reflection layer or a solid substance.

18. The backlight module locating method as claimed in claim 16, wherein the second part relates to a plastic frame, a light guide plate or a diffuser is mounted on the plastic frame; or the second part relates to a lamp fixation holder made in an annular shape to receive insertion of a lamp, and a diffuser is mounted on the lamp fixation holder.

19. The backlight module locating method as claimed in claim 16, wherein two different types of molding materials are contained in their respective feeding cylinders to be injected through two nozzles into a molding area.

20. The backlight module locating method as claimed in claim 16, wherein the molding area contains a first pre-molding area and a second pre-molding area to respectively provide for two different types of molding materials to be respectively molded in shape.
